(19) United States
(12) Patent Application Publication
(10) Pub. No.: US 2011/0090174 A1
(43) Pub. Date: Apr. 21, 2011

(54) DRIVING METHOD OF TOUCH DISPLAY MODULE

(75) Inventor: Chung-Jyh LIN, YongKang (TW)

(73) Assignee: Aussmak Optoelectronics Corp., YongKang City (TW)

(21) Appl. No.: 12/906,833

(22) Filed: Oct. 18, 2010

(30) Foreign Application Priority Data
Oct. 16, 2009 (TW) 098135201

(51) Int. Cl. G06F 3/044

(52) U.S. Cl. 345/174

(57) ABSTRACT

A driving method of a touch display module is disclosed. The driving method includes the steps of writing a liquid crystal (LC) calibration signal to the data line by a calibration signal writing circuit during a blanking time between at least a data line writes the data signals to its corresponding pixel, so that the data line has a specific root mean square (RMS) voltage; and sensing a first sensing signal corresponding to the LC capacitance of the data line and sensing a second sensing signal corresponding to the LC capacitance of at least one scan line. An LC calibration signal is input to the data line during a blanking time between at least a data line writes the data signals to its corresponding pixel to achieve the same background capacitance so as to enhance the accuracy and the efficiency of touch sensing.

### CROSS REFERENCE TO RELATED APPLICATIONS

This Non-provisional application claims priority under 35 U.S.C. §119(a) on Patent Application No(s). 098135201 filed in Taiwan, Republic of China on Oct. 16, 2009, the entire contents of which are hereby incorporated by reference.

### BACKGROUND OF THE INVENTION

1. Field of Invention

The present invention relates to a driving method and, in particular, to a driving method for a touch display module.

2. Related Art

The LCD (liquid crystal display) device has the advantages of low power consumption, less heat generation, less irradiation and light, so that it has been applied in various kinds of electronic products for replacing the conventional CRT (cathode ray tube) display device.

In general, the LCD device mainly includes a LCD panel and a backlight module. The LCD panel includes a TFT substrate, a CF substrate, and a liquid crystal layer, and the two substrates are configured with a plurality of pixels in array. Each pixel can be operated according to the voltage difference between a pixel electrode of the TFT substrate and a common electrode of the CF substrate, so that the desired image can be generated in cooperated with the backlight module.

Recently, the touch panel has been developed and used in many electronic products such as portable communication devices, digital cameras, MP3 players, PDA, GPS, hand-held PC, and UMPC. In these applications, the touch panel is combined with the display screen to form a touch display module. A conventional method for manufacturing the touch display module is to dispose a touch panel on a display panel directly. However, this method can increase the weight and size of the products as well as the manufacturing cost.

Therefore, it is an important subject of the invention to provide a driving method of a touch display module that does not need to configure an additional touch panel and can still achieve the touch control function, thereby making the product more compact and decreasing the manufacturing cost.

### SUMMARY OF THE INVENTION

In view of the foregoing subject, an objective of the present invention is to provide a driving method of a touch display module that can achieve the touch control function without configuring an additional touch panel, thereby making the product more compact and decreasing the manufacturing cost.

To achieve the above, the present invention discloses a driving method of a touch display module, which includes a liquid crystal display (LCD) panel, a calibration signal writing circuit, and a sensing circuit. The LCD panel has an effective display area correspondingly configured with a plurality of scan lines, a plurality of data lines, and a plurality of pixels. Each pixel has at least one charging switch, a pixel electrode, and a common electrode, and the charging switches are electrically connected with the scan lines and the data lines respectively. The scan lines transmit scan signals in sequence to turn on the charging switches, so that the data lines write data signals into the pixel electrodes of the pixels, and the corresponding liquid crystal molecule of each pixel is operated according to the voltage difference between the pixel electrode and the common electrode. The driving method includes the steps of: writing a liquid crystal (LC) calibration signal to at least one of the data lines by the calibration signal writing circuit during a blanking time between the data line writes the data signals to the corresponding pixel, so that the data line has a specific root mean square (RMS) voltage; and when the data line has the specific RMS voltage, sensing a first sensing signal corresponding to an LC capacitance of the data line and sensing a second sensing signal corresponding to an LC capacitance of at least one scan line by the sensing circuit.

As mentioned above, the present invention can use the data lines and scan lines configured on the LCD panel to perform the touch sensing, so that the touch control function can be achieved by sensing the sensing signals of the LC capacitors of the corresponding data line and scan line. Thus, the invention does not need an additional touch panel, so that the product can be more compact and have decreased manufacturing cost. In addition, the invention is to use the calibration signal writing circuit to write the LC calibration signal to the data line during a blanking time between the data line writes the data signals to the corresponding pixel, so that the data line has a specific root mean square (RMS) voltage. Accordingly, the LC capacitors corresponding to all data lines are substantially the same. In other words, the LC capacitors corresponding to different data lines are the same even if the data signals of different data lines are different. Thus, the capacitance variation caused by the touch/press action can be easily sensed so as to enhance the accuracy and the efficiency of touch sensing.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing the layout of a TFT substrate of a LCD panel;

FIG. 2 is an enlarged cross-sectional diagram of the area within the dotted lines of FIG. 1;

FIG. 3 is a block diagram showing a driving method of a touch display module according to an embodiment of the invention;

FIG. 4 is a schematic diagram showing the signals used in the driving method according to the embodiment of the invention;

FIG. 5 is a flow chart of the driving method according to the embodiment of the invention; and

FIGS. 6A and 6B are schematic diagram showing the relations between the RMS voltage and the LC saturate voltage according to the embodiment of the invention.

### DETAILED DESCRIPTION OF THE INVENTION

The present invention will be apparent from the following detailed description, which proceeds with reference to the accompanying drawings, wherein the same references relate to the same elements.

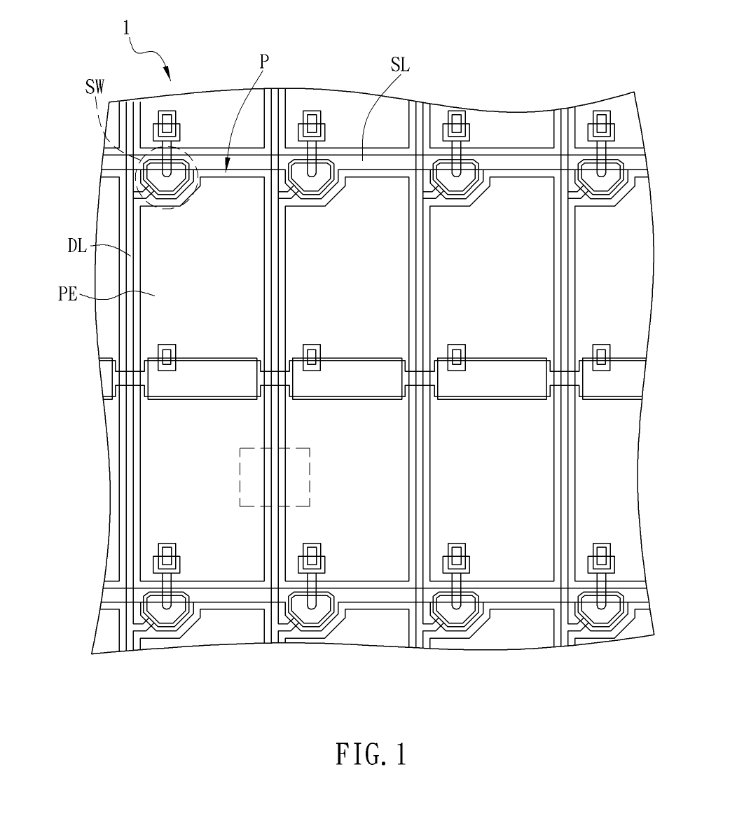

Referring to FIG. 1, a driving method of a touch display module according to an embodiment of the invention is applied to a LCD panel 1, which includes a TFT substrate and a CF substrate. FIG. 1 is a schematic diagram showing the layout of the TFT substrate of the LCD panel 1.

The LCD panel 1 includes an effective display area, which is the area for displaying image and is configured with a plurality of scan lines SL, a plurality of data lines DL, and a plurality of pixels P. Each of the pixels P has at least one charging switch SW, a pixel electrode PE, and a common electrode (not shown, located on the CF substrate and corresponding to the pixel electrode PE). To be noted, FIG. 1 only shows part of the effective display area.

The charging switches SW are electrically connected with the scan lines SL and the data lines DL respectively. The scan lines SL transmit scan signals in sequence to turn on the charging switches SW, so that the data lines DL write data signals into the pixel electrodes PE of the pixels P, and then the corresponding liquid crystal molecule (not shown, disposed between the TFT substrate and the CF substrate) of each of the pixels P is operated according to the voltage difference between the pixel electrode PE and the common electrode. The above-mentioned LCD driving method is well known by the skilled persons in this field, so the detailed descriptions thereof will be omitted.

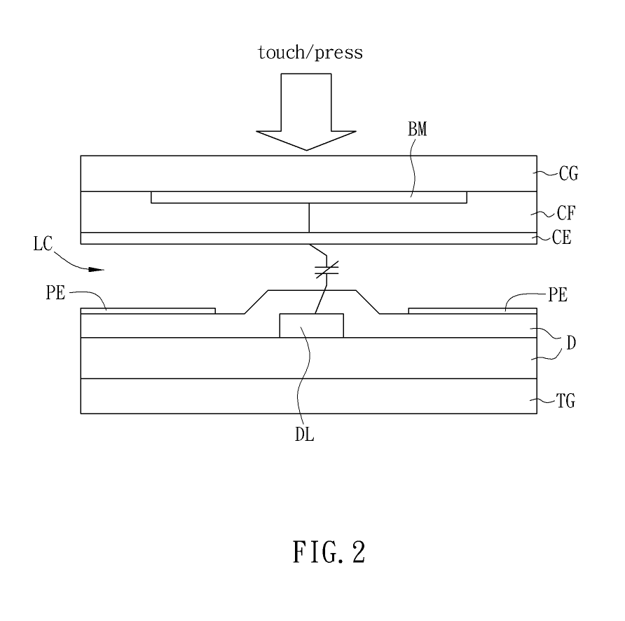

FIG. 2 is an enlarged cross-sectional diagram of the area within the dotted lines of FIG. 1, and FIG. 2 also shows part of the CF substrate. As shown in FIG. 2, the TFT substrate includes a glass substrate TG, two dielectric layers D, a data line DL, and pixel electrodes PE, and the CF substrate includes a glass substrate CG, a black matrix layer BM, a color filter layer CF, and common electrode CE. A liquid crystal layer LC is disposed between the TFT substrate and the CF substrate and includes liquid crystal molecules.

As shown in FIG. 2, the liquid crystal molecule located between the data line DL and the common electrode CE can be operated according to the voltage difference between the data line DL and the common electrode CE, and the operation result can determine the liquid crystal capacitance between the data line DL and the common electrode CE. When a user presses the LCD panel, the distance between the data line DL and the common electrode CE is slightly changed so as to alter the liquid crystal capacitance corresponding to the data line DL. Thus, the altered liquid crystal capacitance can be used to perform the touch control function. Similarly, the liquid crystal capacitance corresponding to the scan line can be altered due to the pressing action, and this altered liquid crystal capacitance can also be used to perform the touch control function.

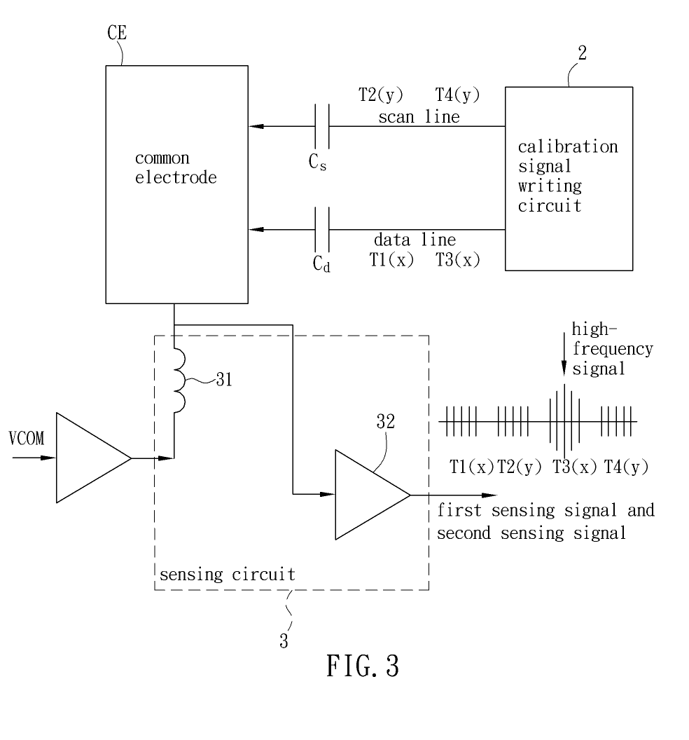

FIG. 3 is a block diagram showing a driving method of a touch display module according to an embodiment of the invention. As shown in FIG. 3, the touch display module includes a calibration signal writing circuit 2 and a sensing circuit 3. In this embodiment, the calibration signal writing circuit 2 is electrically connect with the data line DL and the scan line SL, and the sensing circuit 3 is electrically connected with the common electrode CE.

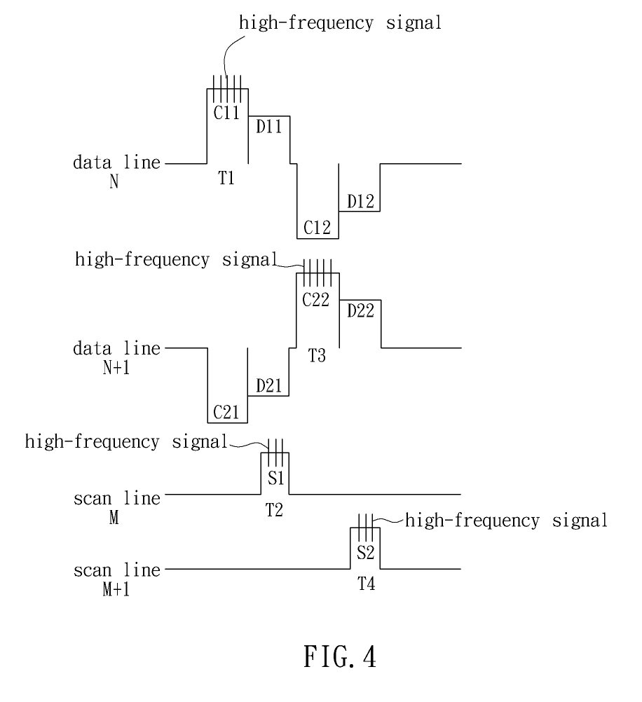

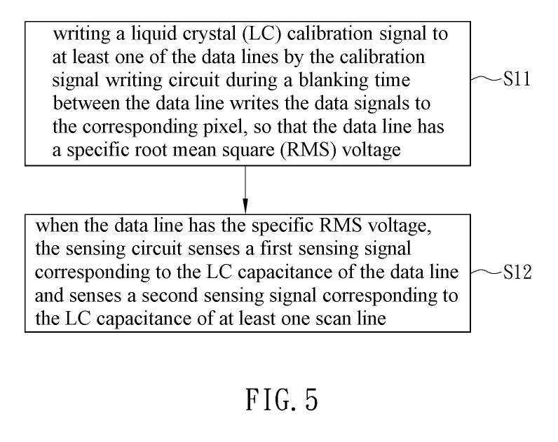

FIG. 4 is a schematic diagram showing the signals used in the driving method according to the embodiment of the invention, and FIG. 5 is a flow chart of the driving method according to the embodiment of the invention. With reference to FIGS. 3, 4 and 5, the driving method according to the embodiment of the invention includes a step S11 to write a liquid crystal (LC) calibration signal to at least one of the data lines DL by the calibration signal writing circuit 2 during a blanking time between the data line DL writes the data signals to the corresponding pixel, so that the data line DL has a specific root mean square (RMS) voltage.

As shown in FIG. 4, taking the data line N as an example, the data signals D11 and D12 are written into the corresponding pixels at time T2 and time T4, respectively, which correspond to the enable time of two adjacent scan lines M and M+1. During the blanking time between the data line DL writes the data signals, such as at time T1 and time T3, the calibration signal writing circuit 2 writes LC calibration signals C11 and C12 to the data line N, so that the data line N can have a specific RMS voltage. Since the liquid crystal molecules are operated according to the RMS voltage, the specific RMS voltage can control the corresponding liquid crystal molecules to substantially stay in the same operation and thus remain in a specific angle, such as in vertical, horizontal, or an angle.

In this embodiment, the LC calibration signal has a high level C11 or C12, which is between two scan signals transmitted through two adjacent scan lines (e.g. the high level C12 at time T3), before a scan signal transmitted through a first scan line of the scan lines (e.g. the high level C11 at time T1), or after a scan signal transmitted through the latest scan line of the scan lines (not shown in FIG. 4). To be noted, the LC calibration signal can be written into the data line in any blanking time of writing the data signals. Because the charging switch of the pixel in turned off during the blanking time of writing the data signals, the LC calibration signal can not affect the display function of the pixels.

In addition, the LC calibration signal can be a DC signal or an AC signal. In this embodiment, the LC calibration signal is an AC signal for example. For instance, the LC calibration signal is in the positive high level C11 at time T1, and in the negative high level C12 at time T3, so that it can be an AC signal. Alternatively, the LC calibration signal can also be a DC signal, so that it is in the positive high level C11 or the negative high level C12 at both time T1 and time T3.

In this embodiment, the calibration signal writing circuit 2 writes the LC calibration signals to the data lines respectively. As shown in FIG. 4, taking the data line N+1 as an example, the data signals D21 and D22 are written into the corresponding pixels at time T2 and time T4, respectively, which correspond to the enable time of two adjacent scan lines M and M+1. During the blanking time between the data line DL writes the data signals, such as at time T1 and time T3, the calibration signal writing circuit 2 writes LC calibration signals C21 and C22 to the data line N+1, so that the data line N+1 can have a specific RMS voltage.

In the embodiment, the LC calibration signal controls the RMS voltage of the data line to be less than, equal to, or greater than an LC saturate voltage. Herein, the LC saturate voltage means the threshold voltage for maintaining the liquid crystal molecules at the same situation.

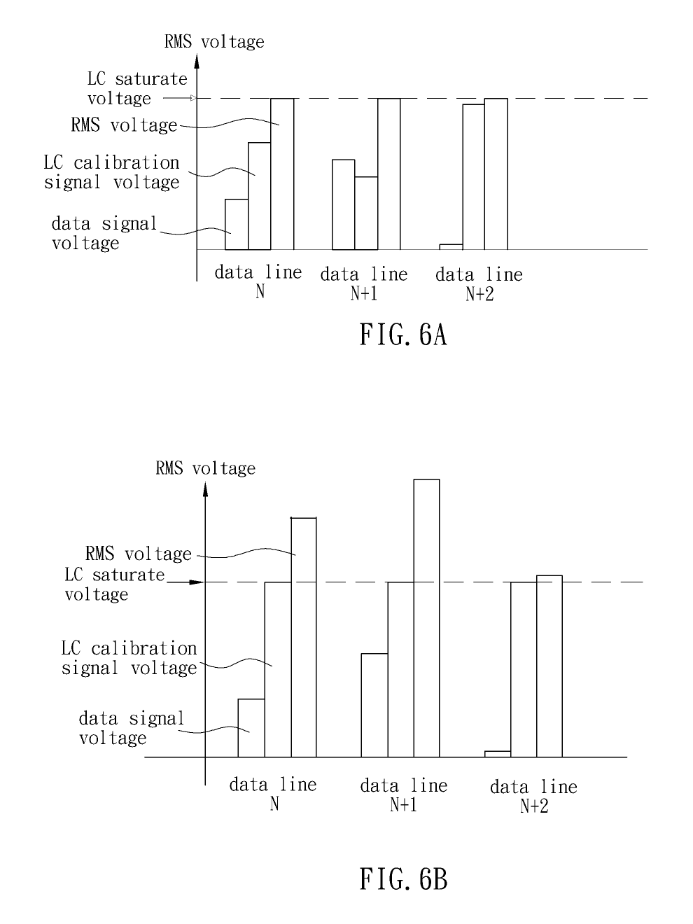

When the RMS voltages of the data lines are equal to the LC saturate voltage, the RMS voltages are substantially the same (equal to the LC saturate voltage), so that the corresponding liquid crystal molecules are in vertical or in horizontal. Herein, if the liquid crystals are the TN (Twisted Nematic) type, the corresponding liquid crystal molecules are in vertical; otherwise, if the liquid crystals are the VA (Vertical Alignment) type, the corresponding liquid crystal molecules are in horizontal. Accordingly, the LC capacitances corresponding to the data lines are the same before the user presses the touch display module. Referring to FIG. 6A with taking the data lines N, N+1, and N+2 as examples, the data lines N, N+1, and N+2 respectively have corresponding data signals, which may be the same or different, and are different in this case. The calibration signal writing circuit 2 writes LC calibration signals into the data lines respectively during the blanking time between writing the data signals, so that the data lines have substantially the same RMS voltage equal to the LC saturate voltage. In this embodiment, the LC calibration signal is obtained by calculation depending on the data signal of the data line, and the amplitudes of the LC calibration signals are different (while the data signals are different).

Otherwise, when the RMS voltages of the data lines are less than the LC saturate voltage, the RMS voltages are substantially the same, so that the corresponding liquid crystal molecules are tilted in the same angle. Accordingly, the LC capacitances corresponding to the data lines are the same before the user presses the touch display module. This case may refer to FIG. 6A and the difference is in that the RMS voltages of the data lines are less than the LC saturate voltage.

Alternatively, when the RMS voltages of the data lines are greater than the LC saturate voltage, the RMS voltages may be substantially the same or different, so that the corresponding liquid crystal molecules are in vertical or in horizontal. Herein, if the liquid crystals are the TN (Twisted Nematic) type, the corresponding liquid crystal molecules are in vertical; otherwise, if the liquid crystals are the VA (Vertical Alignment) type, the corresponding liquid crystal molecules are in horizontal. Accordingly, the LC capacitances corresponding to the data lines are the same before the user presses the touch display module. Referring to FIG. 6B with taking the data lines N, N+1, and N+2 as examples, the data lines N, N+1, and N+2 respectively have corresponding data signals, which may be the same or different, and are different in this case. The calibration signal writing circuit 2 writes the same LC calibration signals (the same amplitude) into the data lines respectively during the blanking time between writing the data signals, so that the RMS voltages of the data lines are all greater than the LC saturate voltage. In this case, the LC calibration signal can be determined according to a reference or the smallest data signal.

In this case, the RMS voltages of the data lines are different. Of course, the LC calibration signals can be obtained by calculation depending on the data signals of the data lines, and the RMS voltages of the data lines may be the same and all greater than the LC saturate voltage.

To be noted, the voltages of the scan lines are in the VGL voltage (usually below −5V) when the screen data of the LCD panel are not renewed. Thus, the voltage difference between the voltages of the scan lines and the common voltage of the common electrode (usually over +3V) is large enough to allow the liquid crystal molecules stay in the saturate situation (in vertical for TN type, or in horizontal for VA type). Thus, the LC capacitances of the scan lines are substantially the same, so the capacitance variation caused by touching/pressing of external objects can be easily recognized. In addition, the VGH voltage (enable voltage) of each scan line can allow the liquid crystal molecules stay in the saturate situation, and the LC capacitances of the scan lines are substantially the same. Of course, if the voltage of the scan line can not make the liquid crystal molecules to stay in the saturate voltage or the scan lines can not make the corresponding LC capacitances to be the same, the application of the LC calibration signals as mentioned above or the likes can be used to make the scan lines to have the same LC capacitance.

As shown in FIG. 5, the driving method further includes a step S12 as follow. When the data line has the specific RMS voltage, the sensing circuit senses a first sensing signal corresponding to the LC capacitance of the data line and senses a second sensing signal corresponding to the LC capacitance of at least one scan line.

Referring to FIG. 4, before the sensing step S12, the LC calibration signal may include a high-frequency signal for performing the following sensing step S12. To be noted, the high-frequency signal is for example only and is not to limit the invention, and this invention may use other auxiliary method to enhance the sensing performance.

In this embodiment, when the calibration signal writing circuit 2 writes the LC calibration signal to the data lines, a high-frequency signal is included. For example, a high-frequency signal is included at time T1 for the data line N, and another high-frequency signal is included at time T3 for the data line N+1. In addition, a high-frequency signal can be included by the calibration signal writing circuit 2 at time T2 when the scan line M transmits the scan signal, and another high-frequency signal can be included by the calibration signal writing circuit 2 at time T4 when the scan line M+1 transmits the scan signal.

Based on the description related to the data lines N and N+1 and the scan lines M and M+1, in the effective display area of the LCD panel, each LC calibration signal has a first high level, each scan signal has a second high level, and the first high levels and the second high levels are interlaced. Furthermore, the high-frequency signals are added into the LC calibration signal and the scan signal in sequence.

With reference to FIG. 3, if the user touches/presses the data line N+1, the sensing circuit can sense a larger high-frequency signal at time T3 so as to recognize that the data line N+1 is touched/pressed. According to this method, it is possible to determine whether the other data lines and scan lines are touched/pressed or not. In other words, this embodiment can recognize the touch points by time.

To be noted, the frequency of the high-frequency signal does not need to be a specific value. In practice, its frequency can be higher if the corresponding LC capacitance of the data line and scan line is smaller; otherwise, its frequency can be lower if the corresponding LC capacitance of the data line and scan line is larger. According to this modification, the effect of sensing the touch/press can be enhanced.

In the above embodiment, the high-frequency signal is included in the LC calibration signal and the scan signal for example. Of course, the high-frequency signal can also be applied to the common electrode CE. In this case, the sensing circuit 3 must be electrically connected with the data lines and scan lines for sensing the first and second sensing signals respectively. The sensing step can be performed by a scanning method to apply to the data lines and scan lines in sequence so as to recognize which data line or scan line is touched/pressed. Alternatively, it is also possible to configure a plurality of sensing elements with respect to all data lines and scan lines for performing the sensing step. However, this method is much more expensive.

As shown in FIG. 3, the sensing circuit 3 includes an inductance element 31 and an amplifier element 32. The inductance element 31 is electrically connected with the common electrode CE and a common power source VCOM. The inductance element 31 can filter the signal to obtain the high-frequency signal, and the amplifier element 32 can amplify the filtered high-frequency signal.

After the sensing circuit 3 senses the first sensing signals (with respect to the data lines) and the second sensing signals (with respect to the scan lines), a comparing step is performed to obtain the touch point. The comparing step can be executed in many methods, and the following description only illustrates three kinds of methods for example.

The first method is to compare the first sensing signals retrieved by sensing the data line at different time. In detailed, only one data line is sensed at different time so as to obtain the first sensing signals. Regarding to the same data line, the retrieved first sensing signals before and after the touch/press action are different, so that it is possible to compare the first sensing signals to recognize whether this data line is touched/pressed or not. Of course, this comparing method can be applied to the scan line.

The second method is to compare the first sensing signals of at least two of the data lines. In this case, since the first sensing signals for all data lines before the touch/press action are substantially the same, it is possible to compare the first sensing signals of at least two data liens to recognize which data line is touched/pressed. Of course, this comparing method can be applied to the scan line.

The third method is to compare the first sensing signal with a first preset reference. In this case, since the first sensing signals for all data lines before the touch/press action are substantially the same, it is possible to compare all first sensing signals with a preset reference to recognize which data line is touched/pressed. Of course, this comparing method can be applied to the scan line

The feature of the present invention is to add the LC calibration signal, so this invention can be applied to various kinds of LCD device. For example, the present invention can be applied to TN type or STN (Super Twisted Nematic) type LCD device. In addition, the present invention can be applied to different display modes such as frame inversion, row inversion, column inversion, and dot inversion. Moreover, the present invention can be applied to the display device with the driving method of including a plurality of charging switches in a single pixel, or with the flip pixel arrangement. Of course, the present invention can be applied to the multi-touch technology for sensing multiple touch points.

In summary, the present invention can use the data lines and scan lines configured on the LCD panel to perform the touch sensing, so that the touch control function can be achieved by sensing the sensing signals of the LC capacitors of the corresponding data line and scan line. Thus, the invention does not need an additional touch panel, so that the product can be more compact and have decreased manufacturing cost. In addition, the invention is to use the calibration signal writing circuit to write the LC calibration signal to the data line during a blanking time between the data line writes the data signals to the corresponding pixel, so that the data line has a specific root mean square (RMS) voltage. Accordingly, the LC capacitors corresponding to all data lines are substantially the same. In other words, the LC capacitors corresponding to different data lines are the same even if the data signals of different data lines are different. Thus, the capacitance variation caused by the touch/press action can be easily sensed so as to enhance the accuracy and the efficiency of touch sensing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A driving method of a touch display module, wherein the touch display module comprises a liquid crystal display (LCD) panel, a calibration signal writing circuit, and a sensing circuit, the LCD panel has an effective display area correspondingly configured with a plurality of scan lines, a plurality of data lines, and a plurality of pixels, each of the pixels has at least one charging switch, a pixel electrode, and a common electrode, the charging switches are electrically connected with the scan lines and the data lines respectively, the scan lines transmit scan signals in sequence to turn on the charging switches, so that the data lines write data signals into the pixel electrodes of the pixels, and corresponding liquid crystal molecules of each of the pixels is operated according to the voltage difference between the pixel electrode and the common electrode, the driving method comprising steps of:
writing a liquid crystal (LC) calibration signal to at least one of the data lines by the calibration signal writing circuit during a blanking time between the data line writes the data signals to the corresponding pixel, so that the data line has a specific root mean square (RMS) voltage; and
when the data line has the specific RMS voltage, sensing a first sensing signal corresponding to an LC capacitance of the data line and sensing a second sensing signal corresponding to an LC capacitance of at least one scan line by the sensing circuit.

2. The driving method of claim 1, further comprising a step of:
comparing first sensing signals retrieved by sensing the data line at different time.

3. The driving method of claim 1, further comprising:
comparing first sensing signals of at least two of the data lines.

4. The driving method of claim 1, further comprising:
comparing the first sensing signal with a first preset reference.

5. The driving method of claim 1, wherein the calibration signal writing circuit writes the LC calibration signal to the data line, so that the liquid crystal molecules corresponding to the data line are in vertical, horizontal, or a specific angle.

6. The driving method of claim 1, wherein the LC calibration signal controls the RMS voltage of the data line to be less than, equal to, or greater than an LC saturate voltage.

7. The driving method of claim 1, wherein the LC calibration signal is obtained by calculation depending on the data signal of the data line.

8. The driving method of claim 1, wherein the LC calibration signal has a high level, which is between scan signals transmitted through two adjacent scan lines, before a scan signal transmitted through a first scan line of the scan lines, or after a scan signal transmitted through a latest scan line of the scan lines.

9. The driving method of claim 1, wherein the LC calibration signal is a DC signal or an AC signal.

10. The driving method of claim 1, wherein the LC calibration signal comprises a high-frequency signal.

11. The driving method of claim 1, wherein the calibration signal writing circuit writes LC calibration signals into the data lines respectively, so that the data lines have substantially the same RMS voltage.

12. The driving method of claim 11, wherein the amplitudes of the LC calibration signals are different.

13. The driving method of claim 1, wherein the calibration signal writing circuit writes LC calibration signals into the data lines respectively, so that the RMS voltages of the data lines are greater than an LC saturate voltage.

14. The driving method of claim 13, wherein the amplitudes of the LC calibration signals are the same.

15. The driving method of claim 1, wherein the calibration signal writing circuit writes LC calibration signals into the data lines respectively, so that each of the LC calibration signals has a first high level, each of the scan signals has a second high level, and the first high levels and the second high levels are interlaced.

16. The driving method of claim 1, wherein the scan signal comprises a high-frequency signal.

17. The driving method of claim 1, wherein the sensing circuit is electrically connected with the common electrode.

18. The driving method of claim 1, further comprising a step of:
filtering and/or amplifying the first sensing signal by the sensing circuit.

19. The driving method of claim 1, wherein the sensing circuit comprises an inductance element electrically connected with the common electrode and a common power source.
